(19) United States
(12) Patent Application Publication
(10) Pub. No.: US 2021/0216514 A1
(43) Pub. Date: Jul. 15, 2021

(54) AUTOMATICALLY ORGANIZING DATA SETS

(71) Applicant: International Business Machines Corporation, Armonk, NY (US)

(72) Inventor: Donald Banks, Ottawa (CA)

(21) Appl. No.: 16/741,251

(22) Filed: Jan. 13, 2020

(51) Int. Cl. G06F 16/22; G06F 16/2455; G06F 17/18; G06F 17/15

(52) U.S. Cl. CPC G06F 16/221; G06F 17/15; G06F 17/18; G06F 16/24554

(57) ABSTRACT

A computer-implemented method for organizing data sets is provided. The method includes analyzing at least a subset of a first column of data in a data structure comprising a plurality of columns of data to determine a pattern. The method also includes determining a split column candidate according to the pattern. The method also includes determining a statistical correlation of the split column candidate with other ones of the plurality of columns of data. The method also includes splitting the first column of data into two columns of data when the statistical correlation of the split column candidate is less than a threshold.

### BACKGROUND

### 1. Field

The disclosure relates generally to computer systems and, more particularly, to computer automated methods for organizing data.

### 2. Description of the Related Art

Business intelligence is the process of analyzing data and presenting actionable information. It has its basis in structured tabular data provided by end users. A table of structured data can be thought of as a collection of rows and columns, where a row is a single instance of the data and a column is a logical attribute of the data.

### SUMMARY

According to one illustrative embodiment, a computer-implemented method for organizing data sets is provided. The method includes analyzing at least a subset of a first column of data in a data structure comprising a plurality of columns of data to determine a pattern. The method also includes determining a split column candidate according to the pattern. The method also includes determining a statistical correlation of the split column candidate with other ones of the plurality of columns of data. The method also includes splitting the first column of data into two columns of data when the statistical correlation of the split column candidate is less than a threshold. According to other illustrative embodiments, a data processing system and computer program product for organizing data sets are provided.

### BRIEF DESCRIPTION OF THE DRAWINGS

FIG. 1 is a pictorial representation of a network of data processing systems in which illustrative embodiments may be implemented;

FIG. 2 is diagram of a computer for automatically splitting a column of data into two columns of data in accordance with an illustrative embodiment;

FIG. 3 is a flowchart of a method for automatically splitting a column of data into two columns of data in accordance with an illustrative embodiment; and

FIG. 4 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account one or more considerations. For example, the illustrative embodiments recognize and take into account that often times, a column in the structured data must be manually prepared for analysis through a tedious process of textual parsing. For example, a column of data for “airline passenger's seat” might include values “1A”, “3F”, “32C”, and so on. This column of data is expressing multiple ideas—the passenger's row number on the plane and, intrinsically, whether the passenger is seated next to a window, an aisle, or in the middle of a row. If a user of a business intelligence application wishes to understand the relationship between the passenger's row number and another column, such as, for example, “passenger satisfaction”, that user would need to take actions to manually split the existing “airline passenger seat” column by parsing the numerical portion and dropping the letter.

The illustrative embodiments recognize and take into account that it would be desirable to have a method, an apparatus, a computer system, and a computer program product that automatically splits columns of structured data into multiple columns in an informationally meaningful manner

In an illustrative embodiment, systems and methods of organizing data sets are provided. In an illustrative embodiment, systems and method for automatically splitting a column of structured data into two or more columns of data in a statistically and informationally meaningful manner are provided. In an illustrative embodiment, a method or system of rules is provided that quickly inspect sample values from a column of data and decide: (1) a rule for how to split the data into additional columns; and (2) the correlation that the new column has with other existing columns, in other words, the “reason” why the column has been split, e.g., it shows a non-trivial correlation with an existing column in the data.

In an illustrative embodiment, given a table of data, the disclosed system operates on a subset of sample rows. For example, if the data has 1,000,000 rows in it, the system may generalize column splitting rules by only examining 1000 randomly selected sample rows.

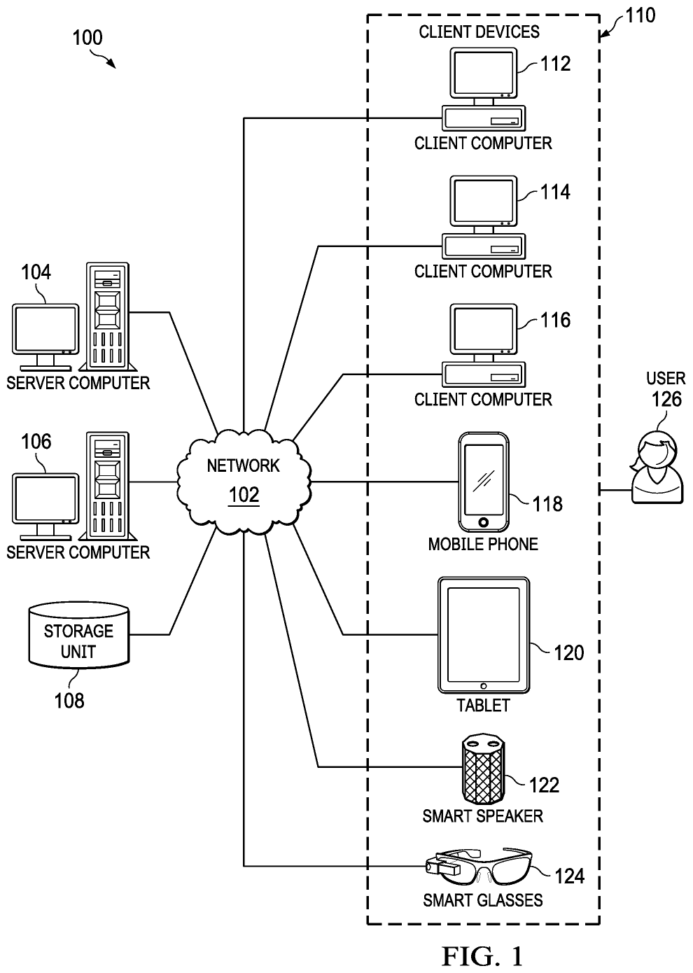

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Further, client devices 110 can also include other types of client devices such mobile phone 118, tablet computer 120, smart speaker 122, and smart glasses 124. Client devices 110 can be, for example, computers, workstations, or network computers. In the depicted example, server computer 104 provides information, such as boot files, operating system images, and applications to client devices 110. In this illustrative example, server computer 104, server computer 106, storage unit 108, and client devices 110 are network devices that connect to network 102 in which network 102 is the communications media for these network devices.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). Network 102 may be comprised of the Internet-of-Things (IoT). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As depicted, structured data arranged into columns and rows is stored on storage unit 108. An analyzer on, for example, server computer 104 or client computer 112 analyzes the structured data to determine patterns in the data that may indicate that a column may be split into multiple statistically relevant columns. The analyzer may apply rules that indicate when a column should be split into multiple columns and rules that indicate that the column should not be split.

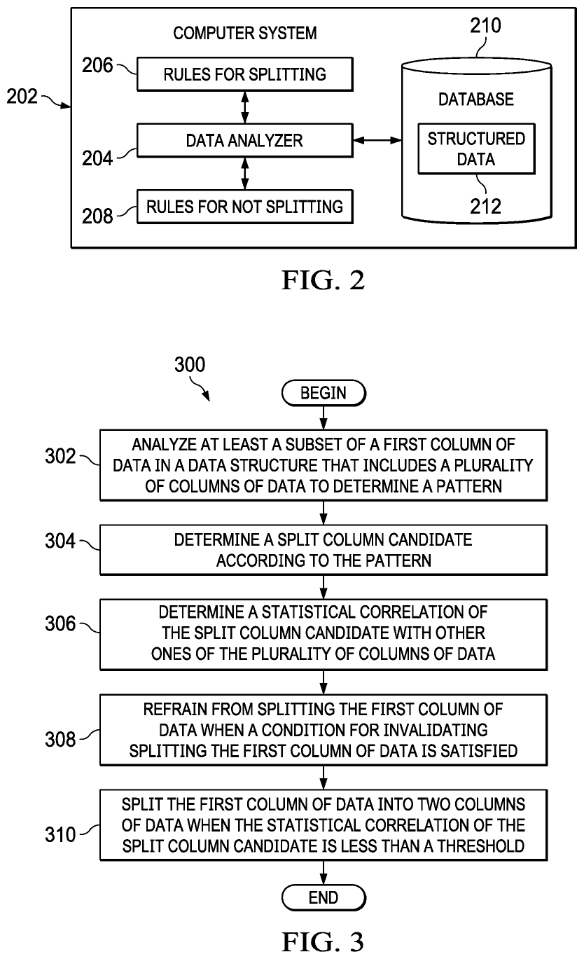

Turning now to FIG. 2, a diagram of a computer for automatically splitting a column of data into two columns of data is depicted in accordance with an illustrative embodiment. The computer system 202 includes a data analyzer 204 and a database 210 that includes structured data 212. In an illustrative embodiment, structured data 212 is data that is formatted into rows and columns. Data analyzer 204 analyzes structured data 212 to find patterns that may indicate that a column in structured data 212 may be split into two or more columns. Splitting a column may provide meaningful information to a user. Data analyzer 204 uses rules for splitting 206 and rules for not splitting 208 in determining whether to split a column of data in structured data 212 into two or more columns of data.

Examples of rules that indicate that a column should be attempted to be split include a rule that reduces all data values to non-alpha-numeric patterns and count the number of distinct patterns. By removing all letters, numbers, and whitespaces from each of the 1000 sample values, one may be left with a pattern of punctuation characters. For example, a column with phone number values “(204)-437-1369”, (780)-455-1929”, and “(204)-889-3939” with all letters and number removed would be left with a common repeated pattern of “( )--”. The same rule holds for data values like “New York, N.Y.”, Edmonton, AB” and so on. In this case, the data set would reduce to the repeated pattern of “,”. If at least a threshold value, such as, for example, 50%, of the data values have the same non-alpha-numeric pattern, the column is a candidate for splitting.

Another example of a rule is a rule to split a column based on alpha or numeric groups of characters. By translating consecutive alphabetical characters into a single character “A”, or consecutive numbers into a single character “N”, the sample values may be reduced into common patterns. In the airline example, “32A”, “3C”, “15F” would all map to a common pattern of “NA” for number followed by an alphabetical character. If a threshold value, for example, at least 50 of the data values have the same alpha-numeric sequence, the column is a candidate for splitting.

Another example of a rule is a rule to split a column based on words separated by white-spaces only. This rule maps any kind of consecutive characters into patterns of words. For example, the sample values, “Senior Manager”, “Senior Electrician”, and “Junior Intern” all fit the pattern “Word Word”. If at least a threshold value, for example, 50%, of the data have the same word pattern by this rule, the column is a candidate for splitting.

Another example of a rule is a rule to split a column based on extraction of a repeated keyword. This rule looks for commonly occurring words within a string of multiple words. For example, job titles may include “Manager of Sales”, “Forensics Manager”, “Senior Manager, Influencer Relations”. Each of these job titles includes the keyword “Manager”. A split column of “Is Manager” could be derived. If at least a first threshold, for example, 20% of the samples have the same keyword and less than a second threshold, for example, 90%, have the same keyword, then the column is a candidate for splitting under this rule.

Note that, in an illustrative embodiment, the aforementioned rules can be piped together as in the output of one rule can be directed as input to another rule. Further note that other rules not disclosed above may also be utilized individually or piped together with one or more of the above disclosed rules.

In an illustrative embodiment, rules that invalidate splitting a column include two rules under which a split column candidate (i.e., a column that is a candidate for splitting according to a rule, such as the rules for splitting a column described above) is discarded. A first rule or condition under which a split column candidate is to be discarded is the condition that the split column has the same, or nearly the same, number of unique values as the original column. A split column has nearly the same unique values as the original when at least a threshold percentage of the number of the entries in the sampled column to be split are the same unique value as in the entries in the candidate split column. The threshold percentage may be implementation dependent. In one illustrative embodiment, the threshold percentage is at least 90% of the entries in the sampled column to be split are the same unique value as in the entries in the candidate split column are the same. In another illustrative embodiment, the threshold percentage is at least 80% of the entries in the sampled column to be split are the same unique value as in the entries in the candidate split column. In another illustrative embodiment, the threshold percentage is at least 25% of the entries in the sampled column to be split are the same unique value as in the entries in the candidate split column.

For example, a column of data called “Defect Severity” may have 4 distinct values “1—Unable to Proceed”, “2—Severely restricted”, “3—Limited Function”, “4—Minor Impact”. When the splitting rules are applied, a split column with the numbers “1”, “2”, “3”, and “4” may be derived. This column can be discarded as it would not add anything meaningful to an end user's analysis. In general, in an illustrative embodiment, if a derived column has within 75% of the original column's domain size (number of distinct values), it is rejected as a split column candidate.

In an illustrative embodiment, another condition in which a split column candidate is rejected is when the split column has a one to one correlation with another column of data. For instance, in the example above in which the job titles are split into “Is Manager”, this splitting may not be worth performing if the idea of “Is Manager” is already represented by a different column within the data set. Likewise, if splitting the area code from a number conforms exactly to the values in a “City” column, then the area code will not offer any additional business value and, therefore, the split column candidate of area code can be discarded.

In statistics, tests, such as, for example, Pearson's Correlation, may be performed between two columns to determine if the column values have a relationship or show no relationship. Thus, in an illustrative embodiment, if a split column candidate correlates with greater than a threshold, for example, greater than 50% correlation, with another column other than the column from which the split column candidate is proposed to be split, the split column candidate is discarded as not adding anything meaningful for an analyst. The threshold value may be user specified and may vary depending on implementation depending on the particular goals and objectives of a project. Accordingly, in an illustrative embodiment, a split column is measured in statistical correlation with other columns (but not with the original column from which it was split). Columns that show non-random relationships with at least one other column can be considered final candidates for user presentation. This test ensures that no “noise” is presented, such as parts of a social insurance number, employee badge number, and so on, which have no predictive qualities to them.

Turning now to FIG. 3, a flowchart of a method for automatically splitting a column of data into two columns of data is depicted in accordance with an illustrative embodiment. Method 300 begins with a data analyzer, such as data analyzer 204, analyzing at least a subset of a first column of data in a data structure that includes a plurality of columns of data to determine a pattern (step 302). Next, the data analyzer determines a split column candidate according to the pattern (step 304). The data analyzer then determines a statistical correlation of the split column candidate with other ones of the plurality of columns of data (step 308). The data analyzer refrains from splitting the first column of data when a condition for invalidating splitting the first column of data is satisfied (step 308). If a condition for invalidating splitting the first column of data is not satisfied, the data analyzer splits the first column of data into two column of data when the statistical correlation of the split column candidate is less than a threshold (step 310).

In an illustrative embodiment, a computer-implemented method for organizing data sets, includes analyzing at least a subset of a first column of data in a data structure comprising a plurality of columns of data to determine a pattern; determining a split column candidate according to the pattern; determining a statistical correlation of the split column candidate with other ones of the plurality of columns of data; and splitting the first column of data into two columns of data when the statistical correlation of the split column candidate is less than a threshold. In an illustrative embodiment, analyzing the subset of the first column of data includes applying a rule to the at least a subset of the first column of data. In an illustrative embodiment, the rule includes reducing all data values to non-alpha-numeric patterns and counting a number of distinct patterns. In an illustrative embodiment, the rule includes translating consecutive alphabetical characters into a first single character, translating consecutive numbers into a second single character, and determining if a threshold number of data values have a same alpha-numeric sequence. In an illustrative embodiment, the rule includes splitting a column into words according to white spaces. In an illustrative embodiment, the rule includes splitting the first column when at least a threshold of cells in the first column comprises a commonly occurring word. In an illustrative embodiment, the method further includes refraining from splitting the first column of data when a condition for invalidating splitting the first column of data is satisfied. In an illustrative embodiment, the condition for invalidating splitting the first column of data includes one of the split column candidate has less than a threshold number of unique values and the split column candidate has a one to one correlation with another column of data. In an illustrative embodiment, analyzing at least the subset of a first column of data includes examining a randomly selected subset of rows in the first column of data.

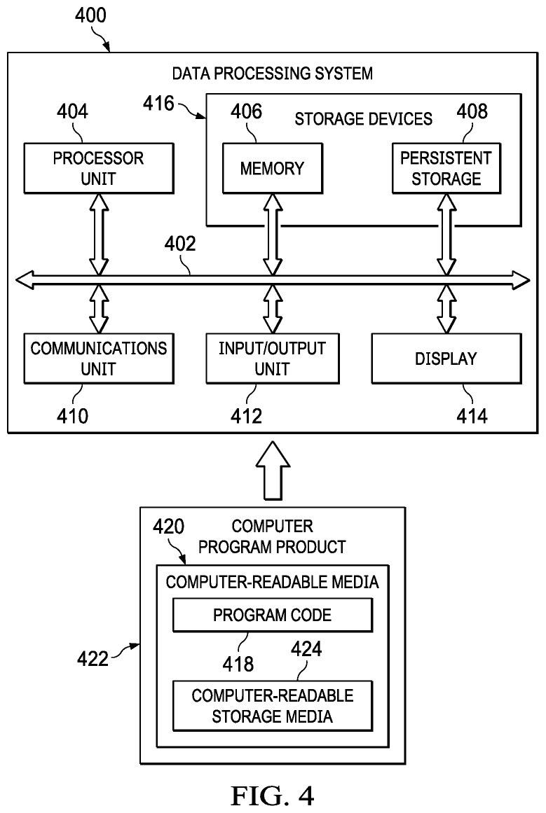

Turning now to FIG. 4, a block diagram of a data processing system is depicted in accordance with an illustrative embodiment. Data processing system 400 can be used to implement server computer 104, server computer 106, and/or one or more of client devices 110, in FIG. 1. Data processing system 400 can also be used to implement computer system 202 in FIG. 2. In this illustrative example, data processing system 400 includes communications framework 402, which provides communications between processor unit 404, memory 406, persistent storage 408, communications unit 410, input/output (I/O) unit 412, and display 414. In this example, communications framework 402 takes the form of a bus system.

Processor unit 404 serves to execute instructions for software that can be loaded into memory 406. Processor unit 404 includes one or more processors. For example, processor unit 404 can be selected from at least one of a multicore processor, a central processing unit (CPU), a graphics processing unit (GPU), a physics processing unit (PPU), a digital signal processor (DSP), a network processor, or some other suitable type of processor. For example, further, processor unit 404 can may be implemented using one or more heterogeneous processor systems in which a main processor is present with secondary processors on a single chip. As another illustrative example, processor unit 404 can be a symmetric multi-processor system containing multiple processors of the same type on a single chip.

Memory 406 and persistent storage 408 are examples of storage devices 416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 416 may also be referred to as computer-readable storage devices in these illustrative examples. Memory 406, in these examples, can be, for example, a random-access memory or any other suitable volatile or non-volatile storage device. Persistent storage 408 may take various forms, depending on the particular implementation.

For example, persistent storage 408 may contain one or more components or devices. For example, persistent storage 408 can be a hard drive, a solid-state drive (SSD), a flash memory, a rewritable optical disk, a rewritable magnetic tape, or some combination of the above. The media used by persistent storage 408 also can be removable. For example, a removable hard drive can be used for persistent storage 408.

Communications unit 410, in these illustrative examples, provides for communications with other data processing systems or devices. In these illustrative examples, communications unit 410 is a network interface card.

Input/output unit 412 allows for input and output of data with other devices that can be connected to data processing system 400. For example, input/output unit 412 may provide a connection for user input through at least one of a keyboard, a mouse, or some other suitable input device. Further, input/output unit 412 may send output to a printer. Display 414 provides a mechanism to display information to a user.

Instructions for at least one of the operating system, applications, or programs can be located in storage devices 416, which are in communication with processor unit 404 through communications framework 402. The processes of the different embodiments can be performed by processor unit 404 using computer-implemented instructions, which may be located in a memory, such as memory 406.

These instructions are referred to as program code, computer usable program code, or computer-readable program code that can be read and executed by a processor in processor unit 404. The program code in the different embodiments can be embodied on different physical or computer-readable storage media, such as memory 406 or persistent storage 408.

Program code 418 is located in a functional form on computer-readable media 420 that is selectively removable and can be loaded onto or transferred to data processing system 400 for execution by processor unit 404. Program code 418 and computer-readable media 420 form computer program product 422 in these illustrative examples. In the illustrative example, computer-readable media 420 is computer-readable storage media 424.

In these illustrative examples, computer-readable storage media 424 is a physical or tangible storage device used to store program code 418 rather than a medium that propagates or transmits program code 418.

Alternatively, program code 418 can be transferred to data processing system 400 using a computer-readable signal media. The computer-readable signal media can be, for example, a propagated data signal containing program code 418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

The different components illustrated for data processing system 400 are not meant to provide architectural limitations to the manner in which different embodiments can be implemented. In some illustrative examples, one or more of the components may be incorporated in or otherwise form a portion of, another component. For example, memory 406, or portions thereof, may be incorporated in processor unit 404 in some illustrative examples. The different illustrative embodiments can be implemented in a data processing system including components in addition to or in place of those illustrated for data processing system 400. Other components shown in FIG. 4 can be varied from the illustrative examples shown. The different embodiments can be implemented using any hardware device or system capable of running program code 418.

Thus, illustrative embodiments of the present invention provide a computer implemented method, computer system, and computer program product for generating lyrics for poetic compositions. The method determines a theme randomly or from input and, from the theme, the method determines words that are associated with the theme and words that rhyme with the associated words according to a star schema approach. The method provides a filter and other mechanisms to tailor the output to fit a specified sentiment, topic, or other feature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for organizing data sets, comprising:
analyzing at least a subset of a first column of data in a data structure comprising a plurality of columns of data to determine a pattern;
determining a split column candidate according to the pattern;
determining a statistical correlation of the split column candidate with other ones of the plurality of columns of data; and
splitting the first column of data into two columns of data when the statistical correlation of the split column candidate is less than a threshold.

2. The method of claim 1, wherein the analyzing comprises applying a rule to the at least a subset of the first column of data.

3. The method of claim 2, wherein the rule comprises reducing all data values to non-alpha-numeric patterns and counting a number of distinct patterns.

4. The method of claim 2, wherein the rule comprises translating consecutive alphabetical characters into a first single character, translating consecutive numbers into a second single character, and determining if a threshold number of data values have a same alpha-numeric sequence.

5. The method of claim 2, wherein the rule comprises splitting a column into words according to white spaces.

6. The method of claim 2, wherein the rule comprises splitting the first column when at least a threshold of cells in the first column comprises a commonly occurring word.

7. The method of claim 1, further comprising:
refraining from splitting the first column of data when a condition for invalidating splitting the first column of data is satisfied.

8. The method of claim 7, wherein the condition for invalidating splitting the first column of data comprise one of the split column candidate has less than a threshold number of unique values and the split column candidate has a one to one correlation with another column of data.

9. The method of claim 1, wherein analyzing at least the subset of a first column of data comprises examining a randomly selected subset of rows in the first column of data.

10. A computer system for organizing data sets, the computer system comprising:
a bus system;
a storage device connected to the bus system, wherein the storage device stores program instructions; and
a processor connected to the bus system, wherein the processor executes the program instructions to:
analyze at least a subset of a first column of data in a data structure comprising a plurality of columns of data to determine a pattern;
determine a split column candidate according to the pattern;
determine a correlation of the split column candidate with other ones of the plurality of columns of data; and
split the first column of data into two columns of data when the correlation of the split column candidate is less than a threshold and when no rules for invalidating splitting the first column of data have been satisfied.

11. The computer system of claim 10, wherein the program instructions to analyze comprises program instructions to apply a rule to the at least a subset of the first column of data.

12. The computer system of claim 11, wherein the rule comprises reducing all data values to non-alpha-numeric patterns and counting a number of distinct patterns.

13. The computer system of claim 11, wherein the rule comprises translating consecutive alphabetical characters into a first single character, translating consecutive numbers into a second single character, and determining if a threshold number of data values have a same alpha-numeric sequence.

14. The computer system of claim 11, wherein the rule comprises splitting a column into words according to white spaces.

15. The computer system of claim 11, wherein the rule comprises splitting the first column when at least a threshold of cells in the first column comprises a commonly occurring word.

16. The computer system of claim 11, wherein the processor further executes the program instructions to:
refrain from splitting the first column of data when a condition for invalidating splitting the first column of data is satisfied.

17. The computer system of claim 16, wherein the condition for invalidating splitting the first column of data comprise one of the split column candidate has less than a threshold number of unique values and the split column candidate has a one to one correlation with another column of data.

18. The computer system of claim 10, wherein the program instructions to analyze at least the subset of a first column of data comprises program instructions to examine a randomly selected subset of rows in the first column of data.

19. A computer program product comprising:
a computer-readable storage medium including instructions for organizing data sets, the instructions comprising:
first program code for analyzing at least a subset of a first column of data in a data structure comprising a plurality of columns of data to determine a pattern;
second program code for determining a split column candidate according to the pattern;
third program code for determining a correlation of the split column candidate with other ones of the plurality of columns of data; and
fourth program code for splitting the first column of data into two columns of data when the correlation of the split column candidate is less than a threshold and when no rules for invalidating splitting the first column of data have been satisfied.

20. The computer program product of claim 19, wherein the analyzing comprises applying a rule to the at least a subset of the first column of data.
